(19) United States
(12) Patent Application Publication
(10) Pub. No.: US 2023/0387524 A1
(43) Pub. Date: Nov. 30, 2023

(54) SEALED STORAGE POWER DEVICE AND METHOD FOR PRODUCING THE SEALED STORAGE POWER DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/303,570

(22) Filed: Apr. 20, 2023

(30) Foreign Application Priority Data
May 26, 2022 (JP) 2022-086255

(51) Int. Cl. H01M 50/186; H01M 50/193; H01M 10/04; H01M 50/325; H01M 50/655

(52) U.S. Cl. CPC H01M 50/186; H01M 50/193; H01M 10/04; H01M 50/325; H01M 50/655

(57) ABSTRACT

A sealed power storage device includes a device case having a metal wall portion formed with liquid inlet, and a sealing member sealing the liquid inlet to cover the liquid inlet from above an outer surface of the metal wall portion. The sealing member is a resin sealing member made of resin. The outer surface of the metal wall portion includes an annular seal surface surrounding an opening edge of the liquid inlet. The resin sealing member includes an annular joined portion hermetically joined to the annular seal surface.

### CROSS-REFERENCE TO RELATED APPLICATIONS

This application is based upon and claims the benefit of priority to Japanese Patent Application No. 2022-086255 filed on May 26, 2022, the entire contents of which are incorporated herein by reference.

### BACKGROUND

### Technical Field

The present disclosure relates to a sealed power storage device and a method for producing the same.

### Related Art

Japanese unexamined patent application publication No. 2007-66600 (JP2007-66600A) discloses a sealed power storage device provided with a device case having a metal wall portion formed with a liquid inlet and a sealing member sealing the liquid inlet. This sealing member is made of metal. Thus, in the sealed power storage device in this publication, the liquid inlet formed in the metal wall portion is sealed with the metal sealing member.

For example, a sealed power storage device configured such that a liquid inlet formed in a metal wall portion is sealed with a metal sealing member, as disclosed the in JP2007-66600A, is produced as follows. Specifically, in a liquid injecting step, an electrolytic solution is injected into a device case through the liquid inlet. In a subsequent sealing step, the liquid inlet is sealed with the metal sealing member formed to cover the liquid inlet from the outer surface side of the metal wall portion. In this sealing step, more specifically, the metal sealing member placed to close the liquid inlet is welded, over its entire circumference, to the metal wall portion by laser welding in which a laser beam is irradiated from above the outer surface of the metal wall portion to the boundary between the metal sealing member and a surrounding part of the outer surface of the metal wall portion, around the liquid inlet, and the vicinity of that boundary. Thus, the liquid inlet is sealed with the metal sealing member.

### SUMMARY

### Technical Problems

However, in such a configuration that the liquid inlet is sealed with the metal sealing member welded to the metal wall portion of the device case, welding failures may occur, leading to inappropriate sealing of the liquid inlet. To address such defects, it has been studied to seal a liquid inlet formed in a metal wall portion of a device case with a resin sealing member made of resin.

The present disclosure has been made to address the above problems and has a purpose to provide a sealed power storage device in which a liquid inlet formed in a metal wall portion of a device case is appropriately sealed with a resin sealing member made of resin, and a method for producing the sealed power storage device.

### Means of Solving the Problems

(1) To achieve the above-mentioned purpose, one aspect of the present disclosure provides a sealed power storage device comprising: a device case including a metal wall portion formed with a liquid inlet; and a sealing member covering the liquid inlet from above an outer surface of the metal wall portion to close the liquid inlet, wherein the sealing member is a resin sealing member made of resin, the outer surface of the metal wall portion includes an annular seal surface surrounding an opening edge of the liquid inlet, and the resin sealing member includes an annular joined portion hermetically joined to the annular seal surface of the metal wall portion.

In the sealed power storage device described above, the liquid inlet in the metal wall portion of the device case is sealed with the resin sealing member made of resin in a manner that covers the liquid inlet from the outer surface side of the metal wall portion, i.e., from above the outer surface of the metal wall portion. This resin sealing member includes the annular joined portion hermetically joined to “the annular seal surface which is a part of the outer surface of the metal wall portion and surrounds the opening edge of the liquid inlet”. With such an annular joined portion, the resin sealing member is hermetically bonded to the metal wall portion, and the liquid inlet is sealed with the resin sealing member. Accordingly, the above-mentioned sealed power storage device is a sealed power storage device in which the liquid inlet formed in the metal wall portion of the device case is appropriately sealed with the resin sealing member.

(2) In the sealed power storage device described in (1), the annular seal surface is an annular roughened surface having an uneven shape with pits and protrusions, and the resin sealing member is hermetically joined to the annular roughened surface by the annular joined portion made of a part of the resin forming the resin sealing member, the part of the resin forming the resin sealing member entering into the pits of the annular roughened surface.

In this sealed power storage device, the annular joined portion of the resin sealing member is hermetically joined to the annular roughened surface with the annular joined portion made of the part of the resin forming the resin sealing member, which enters the pits of the annular roughened surface of the metal wall portion. In other words, the annular joined portion of the resin sealing member is hermetically joined to the annular roughened surface by the anchor effect exerted by biting of the protrusions of the annular roughened surface of the metal wall portion into the annular joined portion of the resin sealing member. This can enhance the hermeticity between the annular joined portion of the resin sealing member and the annular roughened surface of the metal wall portion and hence increase the hermeticity of the sealed power storage device.

(3) In the sealed power storage device described in (1) or (2), the resin sealing member also serves as a safety valve member, and the resin sealing member breaks when an internal pressure of the device case reaches a valve opening pressure to release sealing of the liquid inlet sealed with the resin sealing member.

In this sealed power storage device, the resin sealing member is also used as a safety valve member. Therefore, even if the device case is not provided separately with a gas vent hole and further even if the device case is not provided additionally with a safety valve member for sealing the gas vent hole, when the internal pressure of the device case reaches a valve opening pressure, the resin sealing member breaks, e.g., ruptures to open, allowing the gas in the device case to escape to the outside through the liquid inlet, thus preventing the internal pressure of the device case from excessively rising.

(4) Another aspect of the present disclosure provides a method for producing a sealed power storage device, wherein the sealed power storage device comprises: a device case including a metal wall portion formed with a liquid inlet; and a sealing member covering the liquid inlet from above an outer surface of the metal wall portion to close the liquid inlet, wherein the sealing member is a resin sealing member made of resin, the outer surface of the metal wall portion includes an annular seal surface surrounding an opening edge of the liquid inlet, and the resin sealing member includes an annular joined portion hermetically joined to the annular seal surface of the metal wall portion, wherein the method comprises: injecting an electrolytic solution into the device case through the liquid inlet; and sealing the liquid inlet with the resin sealing member by covering the liquid inlet from above the outer surface of the metal wall portion, and the sealing includes: applying a molten resin to the device case to cover at least the annular seal surface of the outer surface of the metal wall portion and the liquid inlet from above the outer surface of the metal wall portion; and solidifying the molten resin to form the resin sealing member including the annular joined portion hermetically joined to the annular seal surface.

According to the producing method described above, including the coating and the solidifying, it is possible to produce a sealed power storage device in which the liquid inlet formed in the metal wall portion of the device case is appropriately sealed with the resin sealing member made of resin. More specifically, the resin sealing member can be formed including the annular joined portion hermetically joined to the “the annular seal surface which is a part of the outer surface of the metal wall portion and surrounds the opening edge of the liquid inlet”. Since the resin sealing member is formed with such an annular joined portion, the resin sealing member is hermetically joined to the metal wall portion and the liquid inlet is sealed with the resin sealing member. The sealed power storage device having such a structure of sealing the liquid inlet is a sealed power storage device with the liquid inlet properly sealed.

In the coating, a method for applying a molten resin may include for example a hot melt die coating or a curtain coating. Herein, the hot melt die coating is a coating method in which a molten resin is applied in a film form by a die coater. The curtain coting is a coating method in which a molten resin is applied in a film form by a flow coater, i.e., a curtain coater.

In the case of the annular seal surface formed into an annular roughened surface having an uneven shape with pits and protrusions, part of the molten resin applied to the annular roughened surface in the coating flows into the pits of the annular roughened surface. When the molten resin is then solidified in the solidifying, the resin sealing member is formed hermetically joining to the annular roughened surface by the part of resin that has entered into the pits of the annular roughened surface and formed into the annular joined portion.

(5) In the method for producing a sealed power storage device described in (4), further, the annular seal surface is an annular roughened surface with pits and protrusions, and in the applying, when the molten resin is applied to the device case to cover at least the annular roughened surface of the outer surface of the metal wall portion and the liquid inlet from above the outer surface of the metal wall portion, a part of the molten resin applied to the annular roughened surface flows into the pits of the annular roughened surface, and in the solidifying, when the molten resin is solidified, the resin sealing member is formed hermetically joining to the annular roughened surface by the annular joined portion made of the part of the resin forming the resin sealing member, the part of the resin forming the annular joined portion entering the pits of the annular roughened surface.

In the foregoing producing method, the resin sealing member can be formed hermetically joining to the annular roughened surface by the part of resin that has entered the pits of the annular roughened surface of the metal wall portion and formed into the annular joined portion. In other words, this method can form the resin sealing member with the annular joined portion hermetically joined to the annular roughened surface by the anchor effect exerted by biting of the protrusions of the annular roughened surface of the metal wall portion into the annular joined portion of the resin sealing member. This can enhance the hermeticity between the annular joined portion of the resin sealing member and the annular roughened surface of the metal wall portion and hence increase the hermeticity of the sealed power storage device.

(6) The method for producing a sealed power storage device described in (2) or (3) includes: injecting an electrolytic solution into the device case through the liquid inlet; and sealing the liquid inlet with the resin sealing member by covering the liquid inlet from above the outer surface of the metal wall portion, and the sealing includes: applying molten resin to the device case to cover at least the annular seal surface of the outer surface of the metal wall portion and the liquid inlet from above the outer surface of the metal wall portion; and solidifying the molten resin to form the resin sealing member including the annular joined portion hermetically joined to the annular seal surface.

(7) Alternatively, the method for producing a sealed power storage device described in one of (1) to (3) includes: injecting an electrolytic solution into the device case through the liquid inlet; and sealing the liquid inlet with the resin sealing member by covering the liquid inlet from above the outer surface of the metal wall portion, and the sealing includes: placing a resin film onto the device case to cover at least the annular seal surface of the outer surface of the metal wall portion and the liquid inlet from above the outer surface of the metal wall portion; and melting a part of the resin film, the part being located on the annular seal surface, to make molten resin; and solidifying the molten resin to form the resin sealing member including the annular joined portion hermetically joined to the annular seal surface.

According to the producing methods described in (6) and (7), it is possible to produce a sealed power storage device with the liquid inlet formed in the metal wall portion of the device case appropriately sealed with the resin sealing member. More specifically, the resin sealing member can be formed including the annular joined portion hermetically joined to the annular seal surface surrounding the opening edge of the liquid inlet formed in the outer surface of the metal wall portion. Since the resin sealing member is formed with such an annular joined portion, the resin sealing member is hermetically joined to the metal wall portion and the liquid inlet is sealed with the resin sealing member. This sealed power storage device having such a structure of sealing the liquid inlet is a sealed power storage device with the liquid inlet properly sealed.

### BRIEF DESCRIPTION OF THE DRAWINGS

FIG. 1 is a plan view, i.e., a top view, of a sealed power storage device in an embodiment;

FIG. 2 is a front view of the sealed power storage device;

FIG. 3 is a cross-sectional view along B-B in FIG. 1;

FIG. 4 is an enlarged view of a section C in FIG. 3;

FIG. 5 is a flowchart showing the procedure of a method for producing a sealed power storage device in the embodiment;

FIG. 6 is a flowchart showing the procedure of a sealing step in the embodiment;

FIG. 7 is an explanatory view showing a liquid injecting step in the embodiment;

FIG. 8 is an explanatory view showing a surface roughening step in the embodiment;

FIG. 9 is an enlarged cross-sectional view of an annular roughened surface;

FIG. 10 is an explanatory view showing a coating step in the embodiment;

FIG. 11 is another explanatory view of the coating step;

FIG. 12 is an enlarged view of a section D in FIG. 10 and a section F in

FIG. 15;

FIG. 13 is another explanatory view of the coating step;

FIG. 14 is an explanatory view of a coating step in a modified example;

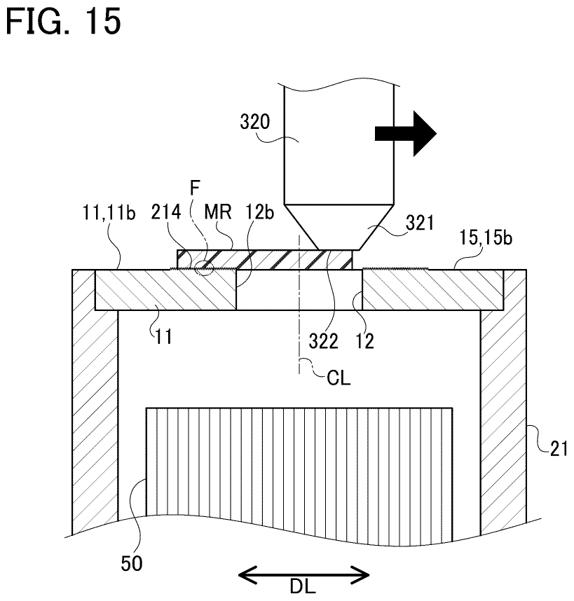

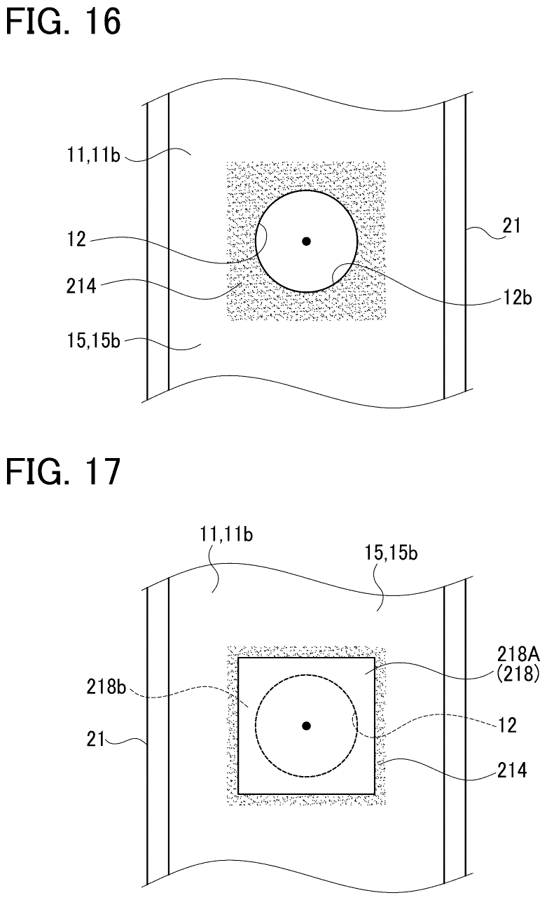

FIG. 15 is another explanatory view of the coating step, corresponding to a cross-sectional view along G-G in FIG. 14;

FIG. 16 is a plan view of an annular roughened surface in a modified example; and

FIG. 17 is an explanatory view of a sealing step in the modified example.

### DETAILED DESCRIPTION OF THE EXEMPLARY EMBODIMENTS

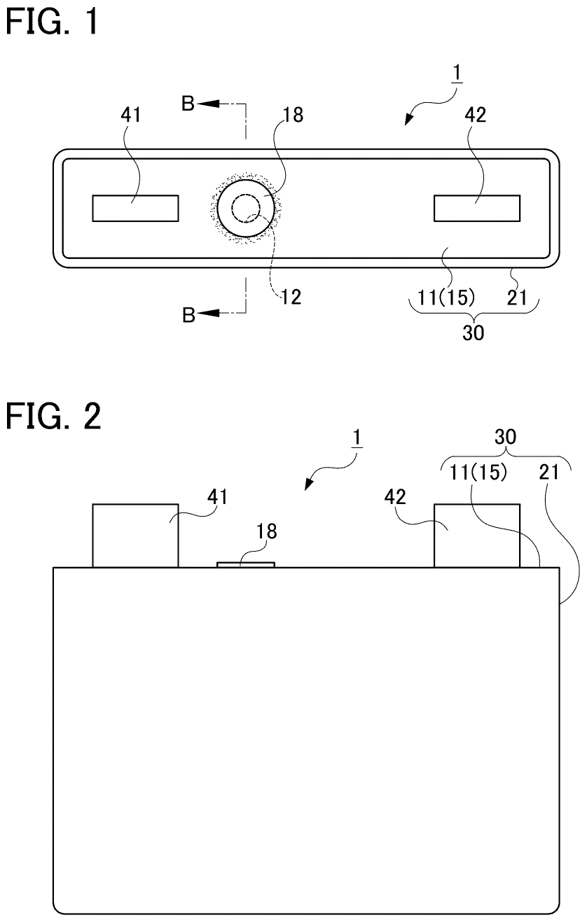

A detailed description of an embodiment of the present disclosure will now be given referring to the accompanying drawings. A sealed power storage device 1 in the present embodiment is a sealed battery, concretely, a lithium-ion secondary battery. This sealed power storage device 1 includes a device case 30, an electrode body 50 accommodated in the device case 30, a positive terminal member 41, and a negative terminal member 42 (see FIGS. 1 to 3). The device case 30 is a hard case made of metal and has a rectangular parallelepiped box-like shape. This device case 30 includes a metal case body 21 having a rectangular tubular shape with a closed bottom, and a metal lid 11 having a rectangular flat plate shape and closing an opening 21b of the case body 21 (see FIGS. 1 to 3). The metal lid 11 includes a metal wall portion 15 formed with a liquid inlet 12. This metal wall portion 15 is a part of the metal lid 11.

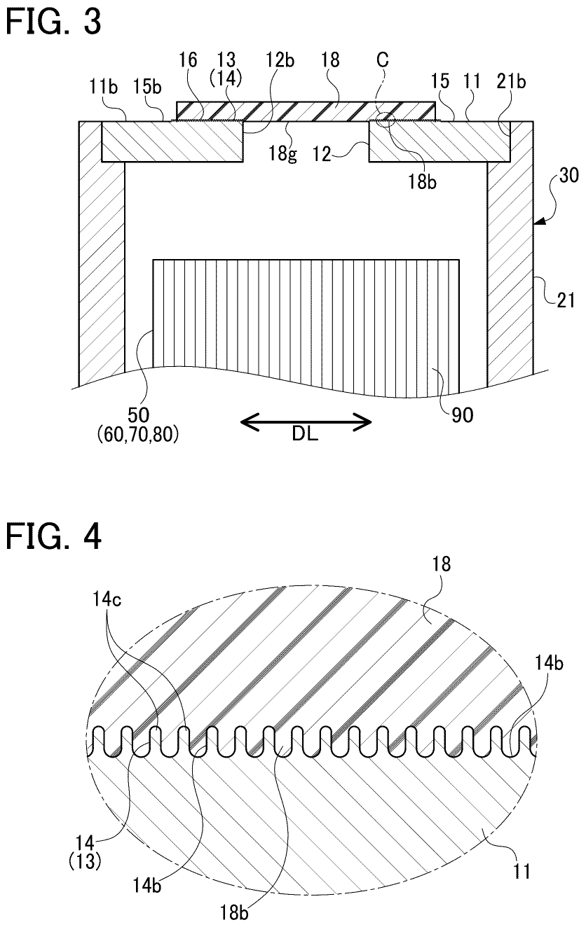

The metal lid 11 has two through holes each having a rectangular tubular shape, which are referred to as a first through hole and a second through hole, not shown. The positive terminal member 41 is inserted through the first through hole, while the negative terminal member 42 is inserted through the second through hole, as shown in FIGS. 1 and 2. In addition, a tubular insulation member (not shown) is interposed between the inner peripheral surface of the first through hole of the metal lid 11 and the outer peripheral surface of the positive terminal member 41 and another tubular insulation member (not shown) is interposed between the inner peripheral surface of the second through hole of the metal lid 11 and the outer peripheral surface of the negative terminal member 42. The metal lid 11, concretely, the metal wall portion 15, is formed with the liquid inlet 12 having a cylindrical shape penetrating through the metal lid 11 in its thickness direction as shown in FIG. 3.

The electrode body 50 includes positive electrode sheets 60, negative electrode sheets 70, and separators 80 each interposed between the positive electrode sheet 60 and the negative electrode sheet 70. More concretely, the electrode body 50 is a lamination electrode body provided with a plurality of positive electrode sheets a plurality of negative electrode sheets 70, and a plurality of separators 80, in which the positive electrode sheets 60 and the negative electrode sheets 70 are alternately laminated, or stacked, with the separators 80 each interposed therebetween in a lamination direction DL as shown in FIG. 3. The electrode body 50 further contains an electrolytic solution 90. This electrolytic solution 90 is further accommodated within the device case 30, on the bottom side. The positive electrode sheets 60 of the electrode body 50 are connected to the positive terminal member 41 through a positive current collecting tab (not shown). The negative electrode sheets are connected to the negative terminal member 45 through a negative current collecting tab (not shown).

Furthermore, the sealed power storage device 1 is provided with a resin sealing member 18 for closing the liquid inlet 12 as shown in FIGS. 1 to 3. This resin sealing member 18 seals the liquid inlet 12 by covering, i.e., closing, the liquid inlet 12 from an outer surface 11b side of the metal lid 11, concretely, from an outer surface 15b side of the metal wall portion 15, i.e., from above the outer surface 11b of the metal lid 11 (the outer surface 15b of the metal wall portion 15). The resin sealing member 18 is made of resin in a circular disk shape. In the present embodiment, the resin sealing member 18 may be made of a resin, which has low permeability to the electrolytic solution 90 and high electrolyte resistance, that is, high resistance to the electrolytic solution 90, and which may be selected, for example, from polyphenylene sulfide (PPS), polyarylene sulfide (PAS), olefin resin, or fluororesin.

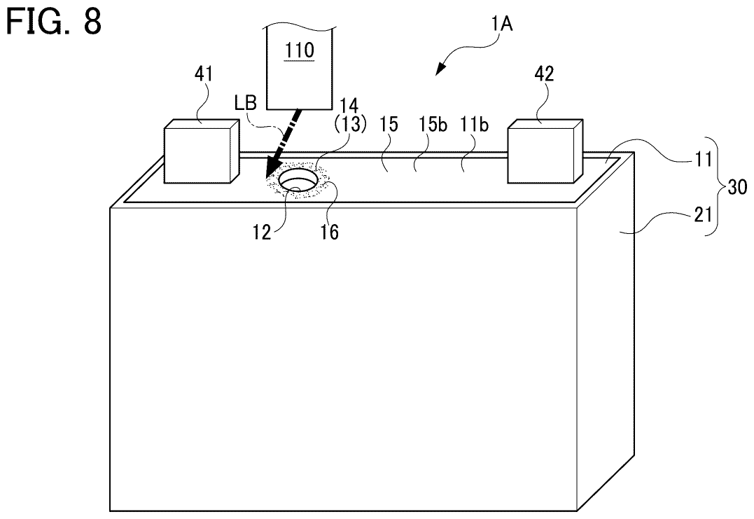

The outer surface 11b of the metal lid 11 (concretely, the outer surface 15b of the metal wall portion 15) includes an annular seal surface 13 having a circular annular shape surrounding the opening edge 12b of the liquid inlet 12 as shown in FIGS. 3 and 8. The resin sealing member 18 includes an annular joined portion 18b hermetically joined to the annular seal surface 13 as shown in FIGS. 3 and 4. The annular joined portion 18b has a circular annular, or circular ring, shape in plan view. The resin sealing member 18 with this annular joined portion 18b is hermetically joined to the metal lid 11, concretely, the metal wall portion 15, and the resin sealing member 18 seals the liquid inlet 12. In the sealed power storage device 1, accordingly, the liquid inlet 12 of the metal wall portion 15 of the device case 30 is appropriately sealed with the resin sealing member 18.

In the present embodiment, especially, the annular seal surface 13 of the metal lid 11 (concretely, of the metal wall portion 15) is an annular roughened surface 14 having an uneven shape with pits 14b and protrusions 14c, as shown in FIG. 4. This annular roughened surface 14 has a circular annular, or circular ring, shape in plan view as shown in FIG. 8. The resin sealing member 18 is hermetically joined to the annular roughened surface 14 by the annular joined portion 18b made of part of the resin forming the resin sealing member 18, part of the resin forming the annular joined portion entering, or penetrating into the pits 14b of the annular roughened surface 14, as shown in FIG. 4. In other words, the annular joined portion 18b of the resin sealing member 18 is hermetically joined to the annular roughened surface 14 by the anchor effect exerted by biting of the protrusions 14c of the annular roughened surface 14 of the metal wall portion 15 into the annular joined portion 18b of the resin sealing member 18. This can enhance the hermeticity between the annular joined portion 18b of the resin sealing member 18 and the annular roughened surface 14 of the metal wall portion 15, and hence increase the hermeticity of the sealed power storage device 1.

The annular roughened surface 14 can be formed by a well-known surface roughening treatment applied to a hole-surrounding surface 16 of the outer surface 11b of the metal lid 11. The hole-surrounding surface 16 is an area of the outer surface 11b of the metal lid 11, concretely, of the outer surface 15b of the metal wall portion located around the opening edge 12b of the liquid inlet 12. This treatment may include, for example, a laser surface treatment, a sandblasting treatment, and an anodizing treatment. One example of the laser surface treatment is disclosed in Japanese unexamined patent application publication No. 2022-028587. In the present embodiment, the hole-surrounding surface 16 of the metal lid 11 is roughened by the the laser surface treatment to form the annular roughened surface 14.

In the sealed power storage device 1 in the present embodiment, the resin sealing member 18 also serves as a safety valve member. Specifically, the resin sealing member 18 functions as a safety valve member for preventing the internal pressure of the device case 30 from excessively rising. When the internal pressure of the device case 30 reaches a valve opening pressure, i.e., a release pressure, the resin sealing member 18 breaks to release the sealing of the liquid inlet 12 sealed with the resin sealing member 18. This allows the gas in the device case 30 to escape to the outside through the liquid inlet 12 to prevent an excessive rise of the internal pressure of the device case 30.

More specifically, when the internal pressure of the device case 30 rises due to the generation of gas in the device case 30, the force that pushes a lower surface 18g of the resin sealing member 18 upward becomes larger, and thus the stress occurring in the resin sealing member 18 increases. When the internal pressure of the device case 30 then reaches the valve opening pressure, the stress generated in the resin sealing member 18 reaches the breaking strength of the resin sealing member 18. At this time, the resin sealing member 18 breaks, e.g., ruptures, forming a venting hole in the resin sealing member 18, so that the liquid inlet 12 is released from sealing. This liquid inlet 12 (concretely, the venting hole formed in the resin sealing member 18) allows the gas to escape from the inside to the outside of the device case 30, thereby preventing an excessive rise of the internal pressure of the device case 30.

Since the resin sealing member 18 is also used as a safety valve member as above, there is neither need to separately provide a gas vent hole in the device case 30, nor to additionally provide a safety valve member for sealing this gas vent hole.

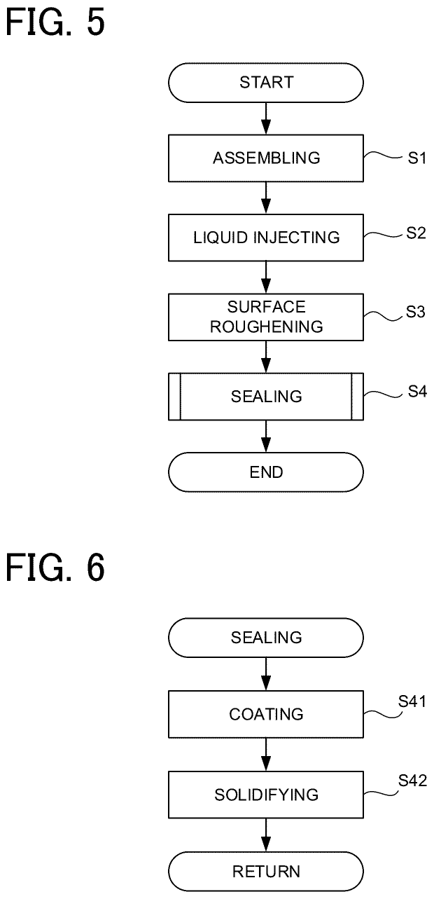

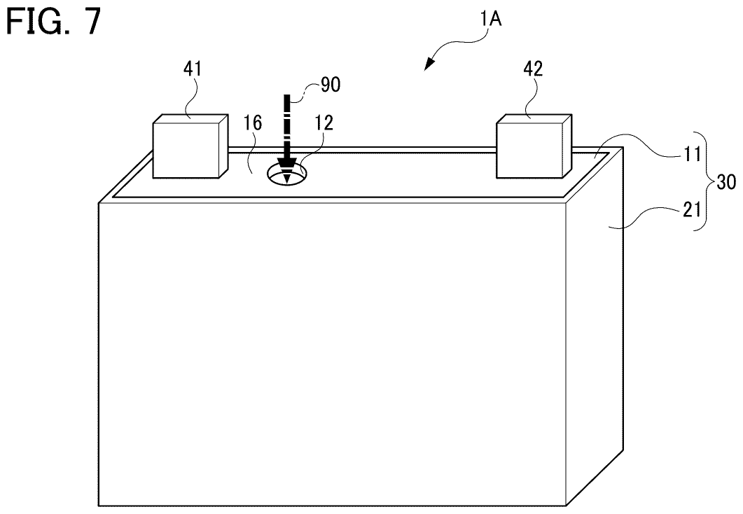

A method of producing the sealed power storage device 1 in the present embodiment will be described below. FIG. 5 is a flowchart showing the procedure of this producing method of the sealed power storage device 1 in the present embodiment. In step S1 (Assembling step), components for the sealed power storage device 1 are assembled first to make an assembled structure 1A (see FIG. 7).

Specifically, the electrode body 50 is fabricated by stacking a plurality of positive electrode sheets 60, a plurality of negative electrode sheets 70, and a plurality of separators 80 so that the positive electrode sheets 60 and the negative electrode sheets 70 are alternately arranged with the separators 80 each interposed between the adjacent electrode sheets 60 and 70 in the lamination direction DL, as shown in FIG. 3. The metal lid 11 formed with the liquid inlet 12 is separately prepared. To this metal lid 11, the positive terminal member 41 and the negative terminal member 42 are fixed as shown in FIGS. 1 and 3.

Subsequently, the positive terminal member 41 fixed to the metal lid 11 is connected to the positive electrode sheets 60 included in the electrode body 50 through a positive current collecting tab (not shown). Similarly, the negative terminal member 42 fixed to the metal lid 11 is connected to the negative electrode sheets 70 included in the electrode body 50 through a negative current collecting tab (not shown). Thus, the metal lid 11 and the electrode body 50 are integrated through the positive terminal member 41 and the negative terminal member 42.

Then, the electrode body 50 integrally combined with the metal lid 11 is inserted in the case body 21 and the metal lid 11 closes the opening 21b of the case body 21. In this state, the metal lid 11 and the case body 21 are welded together over their entire circumference. Accordingly, the case body 21 and the metal lid 11 are bonded, forming the device case 30 and producing the assembled structure 1A as shown in FIG. 7. At this time, the liquid inlet 12 is not sealed with the resin sealing member 18 and remains open.

In step S2 (Liquid-injecting step), as shown in FIG. 7, the electrolytic solution 90 is injected into the device case 30 through the liquid inlet 12 of the metal lid 11 of the assembled structure 1A. The electrolytic solution 90 is thus impregnated in the electrode body 50 and further is accommodated within the device case 30, on its bottom side. In the present embodiment, the electrolytic solution 90 is a nonaqueous electrolytic solution containing organic solvent (e.g., ethylene carbonate, ethyl methyl carbonate, and dimethyl carbonate) and LiPF₆.

In step S3 (Surface roughening step), the hole-surrounding surface 16 of the metal lid 11 is processed into the annular roughened surface 14 by the laser surface treatment as shown in FIG. 8. This hole-surrounding surface 16 is a part of the outer surface 11b of the metal lid 11, concretely, a part of the outer surface 15b of the metal wall portion 15, located around the opening edge 12b of the liquid inlet 12.

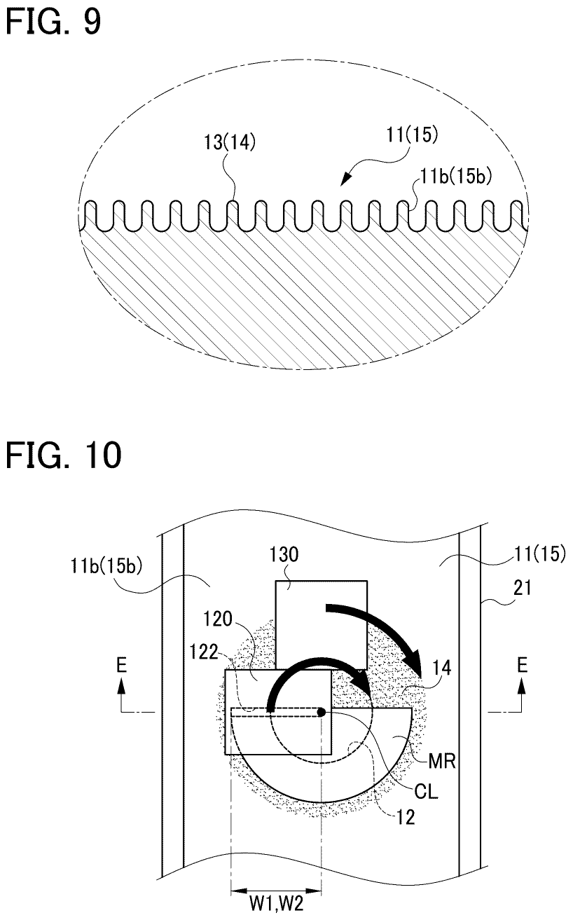

Specifically, as shown in FIG. 8, a laser beam LB is applied onto the hole-surrounding surface 16 of the metal lid 11 by a known laser device 110 to roughen the hole-surrounding surface 16. This laser beam LB is irradiated in a circular pattern along the outer circumference of the opening edge 12b of the liquid inlet 12. To be concrete, the laser beam LB is irradiated onto the hole-surrounding surface 16 of the metal lid 11 from a portion close to the opening edge 12b of the liquid inlet 12 so as to draw a plurality of concentric circles. As a result, the annular roughened surface 14 having an uneven shape with pits 14b and protrusions 14c, can be formed on the outer surface 11b of the metal lid 11 (concretely, the outer surface 15b of the metal wall portion 15) as the circular annular seal surface 13 surrounding the opening edge 12b of the liquid inlet 12 (see FIG. 9).

In step S4 (Sealing step), the liquid inlet 12 is sealed with the resin sealing member 18. In other words, the resin sealing member 18 for sealing the liquid inlet 12 is formed. FIG. 6 is a flowchart showing the procedure of the sealing step in S4 in the present embodiment. As shown in FIG. 6, the sealing step in S4 includes a step S41 (Coating step) and a step S42 (Solidifying step).

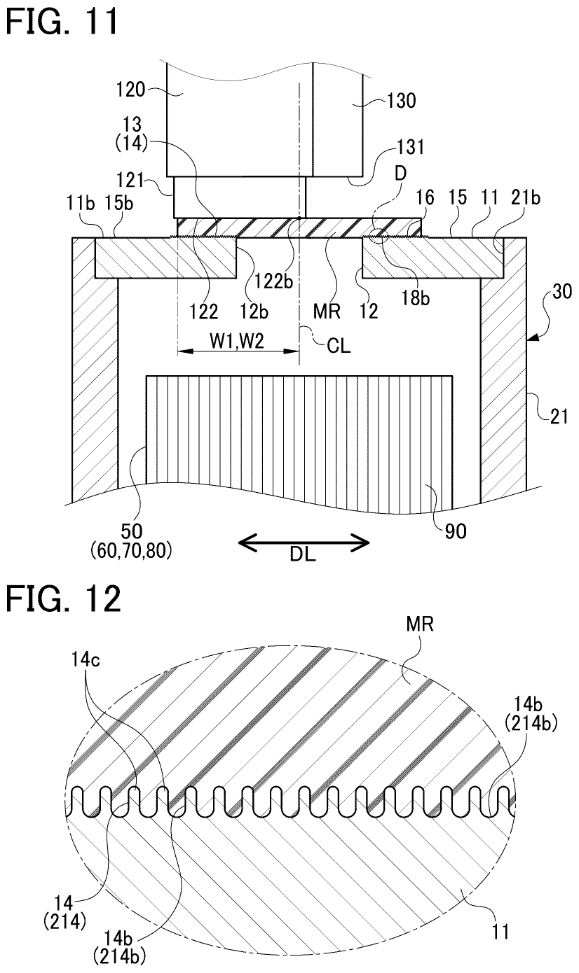

To be concrete, in the coating step in S41, a molten resin MR is applied onto the device case 30 so as to cover the annular roughened surface 14, which is the annular seal surface 13, and the opening edge 12b of the liquid inlet 12, from above the outer surface 11b of the metal lid 11, concretely, the outer surface 15b of the metal wall portion 15, as shown in FIGS. 10 and 11. The molten resin MR is the resin in a molten state used to form the resin sealing member 18. FIG. 10 is a plan, or top, view showing how to perform the coating step. FIG. 11 is a side view including a partial cross-section, showing how to perform the coating step, which corresponds to a partial cross-sectional view along E-E in FIG. 10.

The coating step in S41 in the present embodiment is performed using a heater 130 (e.g., an infrared heater) provided with a heating part 131 and a die coater 120 provided with a nozzle 121 as shown in FIGS. 10 and 11. Specifically, the annular roughened surface 14 is heated by the heating part 131 of the heater 130 and the molten resin MR is applied in a film form by the die coater 120 so as to cover the heated annular roughened surface 14 and the opening edge 12b of the liquid inlet 12.

More specifically, the heater 130 placed above the outer surface 11b of the metal lid 11 (concretely, the outer surface 15b of the metal wall portion 15) is moved to revolve in a circumferential direction along the outer circumference of the opening edge 12b of the liquid inlet 12, i.e., the inner circumference of the annular roughened surface 14, about a central axis CL of the liquid inlet 12, as shown in FIGS. 10 and 11. The annular roughened surface 14 is thus heated sequentially in the circumferential direction by the heating part 131 of the heater 130. Heating by movement of the heater 130 is terminated at the time when the heating part 131 of the heater 130 moves in a full circle on the annular roughened surface 14, i.e., when the heater 130 makes one revolution about the central axis CL of the liquid inlet 12. In the coating step in the present embodiment, the annular roughened surface 14 is heated to a temperature of 100° C. or higher by the heater 130.

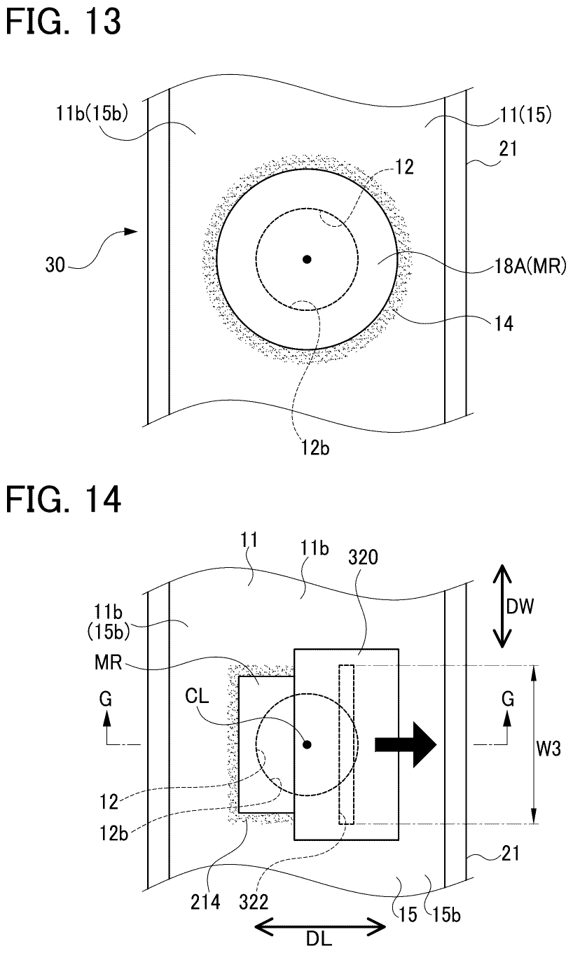

Furthermore, following the movement of the heater 130, the die coater 120 placed above the outer surface 11b of the metal lid 11, i.e., the outer surface 15b of the metal wall portion 15, is moved to rotate in the circumferential direction along the outer circumference of the opening edge 12b of the liquid inlet 12, i.e., the inner circumference of the annular roughened surface 14, about the central axis CL of the liquid inlet 12, while ejecting the molten resin MR from an ejection port 122 of the nozzle 121, as shown in FIGS. 10 and 11. The molten resin MR is thus applied in a film form by the die coater 120 in the form that covers the annular roughened surface 14 heated by the heater 130 and the opening edge 12b of the liquid inlet 12. At this time, part of the molten resin MR applied over the annular roughened surface 14 flows into the pits 14b of the annular roughened surface 14 as shown in FIG. 12.

The width W1 of the ejection port 122 of the nozzle 121 and the width W2 of the molten resin MR ejected from the ejection port 122 of the nozzle 121 are equal to the radius of a molten resin film 18A to be formed in a circular disk shape (see FIG. 13). As described below, when solidified, the molten resin film 18A becomes the resin sealing member 18. The die coater 120 moves to rotate so that the ejection port 122 of the nozzle 121 rotates, or turns, about the central axis CL of the liquid inlet 12 while aligning a one end 122b of the ejection port 122 in its width direction with the central axis CL of the liquid inlet 12. Therefore, the molten resin MR ejected from the ejection port 122 of the nozzle 121 forms a film of a circular sector shape in plan view centered at the central axis CL of the liquid inlet 12. As the rotational movement of the die coater 120 progresses, the central angle of the circular sector-shaped film increases.

Accordingly, when the nozzle 121 of the die coater 120 turns a full circle along the inner circumference of the annular roughened surface 14, that is, the die coater 120 makes one rotation about the central axis CL of the liquid inlet 12, the molten resin film 18A is formed in a circular disk shape covering over the annular roughened surface 14 and the opening edge 12b of the liquid inlet 12 as shown in FIG. 13. Thus, application of the molten resin MR by movement of the die coater 120 is terminated at the time when the nozzle 121 of the die coater 120 has turned a full circle along the inner circumference of the annular roughened surface 14, that is, when the die coater 120 makes one rotation about the central axis CL of the liquid inlet 12. FIG. 13 is a plan view of the molten resin film 18A and the device case 30 seen from above the device case 30 at the time when the coating step is terminated.

In step S42 (Solidifying step), the molten resin film 18A made of the molten resin MR is solidified to form the resin sealing member 18. In the present embodiment, the molten resin film 18A is solidified by natural cooling. As a result, the circular disk-shaped resin sealing member 18 is formed with the annular joined portion 18b hermetically joined to the annular seal surface 13, which is a part of the outer surface of the metal wall portion 15 and surrounds the opening edge 12b of the liquid inlet 12, as shown in FIGS. 1 and 3. In this manner, the sealed power storage device 1 is produced in which the liquid inlet 12 of the metal wall portion 15 of the device case is appropriately sealed with the resin sealing member 18 made of resin.

In the present embodiment, particularly, the annular seal surface 13 is formed as the annular roughened surface 14 having an uneven shape with the pits 14b and protrusions 14c. In the coating step in S41, accordingly, a part of the molten resin MR applied to the annular roughened surface 14 flows into the pits 14b of the annular roughened surface 14 as shown in FIG. 12. When the molten resin MR is then solidified in the solidifying step in S42, the resin sealing member 18 is formed with the annular joined portion 18b hermetically joining to the annular roughened surface 14 by entering of the part of the resin, which forms the annular joined portion 18b, into the pits 14b of the annular roughened surface 14 as shown in FIG. 4. This can enhance the hermeticity between the annular joined portion 18b of the resin sealing member 18 and the annular roughened surface 14 of the metal wall portion 15 and hence increase the hermeticity of the sealed power storage device 1.

In the liquid injecting step in S2, meanwhile, when the electrolytic solution 90 is injected into the device case 30 through the liquid inlet 12 of the metal lid 11, the electrolytic solution 90 may adhere to a part of the outer surface 11b of the metal lid 11, which is located around the opening edge 12b of the liquid inlet 12, i.e., the hole-surrounding surface 16. Accordingly, if the liquid injecting step is performed after the surface roughening step, there is a possibility that the electrolytic solution 90 sticks to the annular roughened surface 14 in the liquid injecting step, and then the sealing step is performed for the annular roughened surface 14 on which the electrolytic solution 90 remains adhering. In this case, the components of the electrolytic solution 90 may intervene between the annular roughened surface 14 of the metal lid 11 and the annular joined portion 18b of the resin sealing member 18. Such a condition is undesirable.

In contrast, in the present embodiment, the surface roughening step (step S3) using the laser surface treatment is performed before the sealing step (step S4) and after the liquid injecting step (step S2). Accordingly, even if the electrolytic solution adheres to the hole-surrounding surface 16 of the metal lid 11 in the liquid injecting step in S2, in the following surface roughening step in S3, a laser beam LB is irradiated onto the hole-surrounding surface 16 of the metal lid 11, which is a portion to be formed into the annular roughened surface 14. Therefore, the electrolytic solution 90 adhered to the hole-surrounding surface 16 is evaporated and removed. The annular roughened surface 14 to which no electrolytic solution 90 adheres is thus formed. In the present embodiment, therefore, the sealing step can be carried out with the annular roughened surface 14 having no electrolytic solution 90 adhering thereto, which can prevent the electrolytic solution 90 from intervening between the annular roughened surface 14 of the metal lid 11 and the annular joined portion 18b of the resin sealing member 18.

The foregoing embodiments are mere examples and give no limitation to the present disclosure. The present disclosure may be embodied in other specific forms without departing from the essential characteristics thereof.

For instance, in the coating step in the present embodiment, the molten resin film 18A is formed in a manner that the die coater 120 placed above the outer surface 11b of the metal lid 11 is moved in the circumferential direction along the outer circumference of the opening edge 12b of the liquid inlet 12 to rotate about the central axis CL of the liquid inlet 12 while ejecting the molten resin MR from the ejection port 122 of the nozzle 121.

However, an alternative may use a die coater 320 including a nozzle 321 with an ejection port 322 having a width W3 larger than the diameter of the liquid inlet 12 to form a molten resin film 218A having a rectangular plate-like shape. In this example, the molten resin film 218A is solidified to form a resin sealing member 218 of a rectangular plate-like shape as shown in FIGS. 14 to 17. A method for producing this alternative example will be described below in detail as a modified example.

The coating step is described first. Specifically, the die coater 320 is placed above the outer surface 11b of the metal lid 11 in such an orientation that the width direction DW of the ejection port 322 of the die coater 320 is perpendicular to the lamination direction DL of the electrode body 50 and besides the ejection port 322 faces downward as shown in FIGS. 14 and 15. However, the die coater 320 is arranged such that, in plan view, the ejection port 322 of the die coater 320 is located adjacent to the opening edge 12b of the liquid inlet 12 on one side (i.e., the left side in FIGS. 14 and 15) in the lamination direction DL and further the center of the ejection port 322 in the width direction and the central axis CL of the liquid inlet 12 are spaced apart in the lamination direction DL in plan view. At that time, the ejection port 322 of the die coater 320 is positioned above and opposed to an annular roughened surface 214. The annular roughened surface 214 in this modified example has an annular shape surrounding the opening edge 12b of the liquid inlet 12, specifically, having a circular inner circumference (concretely, a circular shape along the outer circumference of the opening edge 12b of the liquid inlet 12) and a rectangular outer circumference.

Subsequently, while ejecting the molten resin MR from the ejection port 322 of the nozzle 321, the die coater 320 is moved to the other side (i.e., to the right in FIGS. 14 and 15) in the lamination direction DL. After the ejection port 322 of the nozzle 321 passes above the opening edge 12b of the liquid inlet 12, the ejection of the molten resin MR from the ejection port 322 is stopped. Accordingly, the annular roughened surface 214, which is a part of the outer surface 15b of the metal wall portion 15, is coated with the molten resin MR and further the liquid inlet 12 is covered by the molten resin MR in a film form bridging over the liquid inlet 12. In other words, the molten resin MR is applied in a film form by the die coater 120 to cover the annular roughened surface 214 and the opening edge 12b of the liquid inlet 12 to form the molten resin film 218A of a rectangular plate-like shape, as shown in FIG. 17. During this process, part of the molten resin MR applied to the annular roughened surface 214 flows in the pits 214b of the annular roughened surface 214 as shown in FIG. 12. The annular roughened surface 214 may be heated by a heater not shown prior to application of the molten resin MR by the dye coater 320.

In the subsequent solidifying step, the molten resin film 218A made of the molten resin MR is solidified, forming the resin sealing member 218 of a rectangular plate-like shape as shown in FIG. 17. Consequently, the rectangular plate-shaped resin sealing member 218 is formed with the annular joined portion 218b hermetically joined to the annular roughened surface 214, which is a part of the outer surface 15b of the metal wall portion 15 and surrounds the opening edge 12b of the liquid inlet 12. In the above-described embodiment, the molten resin MR is applied to the device case 30 so as to cover over the annular roughened surface 14 and the opening edge 12b of the liquid inlet 12 from the outer surface 11b side of the metal lid 11, and then the applied molten resin MR is solidified, forming the resin sealing member 18 sealing the liquid inlet 12. However, as described below, a resin film prepared in advance may be welded to the outer surface 11b of the metal lid 11 to form a resin sealing member made of the resin film.

Specifically, in a disposing step, a resin film is disposed on the device case so as to cover, from the outer surface 15b side of the metal wall portion 15, at least the annular roughened surface 14, which is the annular seal surface 13 of the outer surface 15b of the metal wall portion 15, and the liquid inlet 12. In a following melting step, a part of the resin film, located on the annular roughened surface 14, is melted into a molten resin by for example a heating device. At this time, a part of the molten resin located on the annular roughened surface 14 flows into the pits 14b of the annular roughened surface 14. In the solidifying step, this molten resin is solidified, forming an annular joined portion hermetically joined to the annular roughened surface 14, so that a resin sealing member sealing the liquid inlet 12 is formed. More specifically, the resin sealing member is formed with the annular joined portion hermetically bonded to the annular roughened surface 14 by entering of the part of the resin forming the annular joined portion into the pits 14b of the annular roughened surface 14. In this producing method, the sealing step includes the disposing step, the melting step, and the solidifying step.

The above-described embodiment exemplifies the sealed power storage device 1 provided with the resin sealing member 18 that seals the liquid inlet 12 formed in the metal wall portion 15 of the metal lid 11. The present disclosure however includes a sealed power storage device provided with a resin sealing member that seals a liquid inlet formed in a metal wall portion of a case body 21.

### REFERENCE SIGNS LIST

1 Sealed power storage device
11 Metal lid
11b Outer surface
12 Liquid inlet
12b Opening edge
13 Annular seal surface
14, 214 Annular roughened surface
14b, 214b Pit
15 Metal wall portion
15b Outer surface
18, 218 Resin sealing member (Sealing member)
18A, 218A Molten resin film
18b, 218b Annular joined portion
21 Case body
30 Device case
50 Electrode body
90 Electrolytic solution
MR Molten resin
S2 Liquid injecting step
S4 Sealing step
S41 Coating step
S42 Solidifying step

What is claimed is:

1. A sealed power storage device comprising:
a device case including a metal wall portion formed with a liquid inlet; and
a sealing member covering the liquid inlet from above an outer surface of the metal wall portion to close the liquid inlet,
wherein the sealing member is a resin sealing member made of resin,
the outer surface of the metal wall portion includes an annular seal surface surrounding an opening edge of the liquid inlet, and
the resin sealing member includes an annular joined portion hermetically joined to the annular seal surface of the metal wall portion.

2. The sealed power storage device according to claim 1, wherein
the annular seal surface is an annular roughened surface having an uneven shape with pits and protrusions, and
the resin sealing member is hermetically joined to the annular roughened surface by the annular joined portion made of a part of the resin forming the resin sealing member, the part of the resin forming the resin sealing member entering into the pits of the annular roughened surface.

3. The sealed power storage device according to claim 1, wherein
the resin sealing member also serves as a safety valve member, and
the resin sealing member breaks when an internal pressure of the device case reaches a valve opening pressure to release sealing of the liquid inlet sealed with the resin sealing member.

4. The sealed power storage device according to claim 2, wherein
the resin sealing member also serves as a safety valve member, and
the resin sealing member breaks when an internal pressure of the device case reaches a valve opening pressure to release sealing of the liquid inlet sealed with the resin sealing member.

5. A method for producing a sealed power storage device,
wherein the sealed power storage device comprises:
a device case including a metal wall portion formed with a liquid inlet; and
a sealing member covering the liquid inlet from above an outer surface of the metal wall portion to close the liquid inlet,
wherein the sealing member is a resin sealing member made of resin,
the outer surface of the metal wall portion includes an annular seal surface surrounding an opening edge of the liquid inlet, and
the resin sealing member includes an annular joined portion hermetically joined to the annular seal surface of the metal wall portion,
wherein the method comprises:
injecting an electrolytic solution into the device case through the liquid inlet; and
sealing the liquid inlet with the resin sealing member by covering the liquid inlet from above the outer surface of the metal wall portion, and
the sealing includes:
applying a molten resin to the device case to cover at least the annular seal surface of the outer surface of the metal wall portion and the liquid inlet from above the outer surface of the metal wall portion; and
solidifying the molten resin to form the resin sealing member including the annular joined portion hermetically joined to the annular seal surface.

6. The method for producing a sealed power storage device according to claim 5, wherein
the annular seal surface is an annular roughened surface with pits and protrusions, and
in the applying,
when the molten resin is applied to the device case to cover at least the annular roughened surface of the outer surface of the metal wall portion and the liquid inlet from above the outer surface of the metal wall portion, a part of the molten resin applied to the annular roughened surface flows into the pits of the annular roughened surface, and
in the solidifying,
when the molten resin is solidified, the resin sealing member is formed hermetically joining to the annular roughened surface by the annular joined portion made of the part of the resin forming the resin sealing member, the part of the resin forming the annular joined portion entering the pits of the annular roughened surface.
